(19) United States
(12) Patent Application Publication
(10) Pub. No.: US 2016/0059252 A1
(43) Pub. Date: Mar. 3, 2016

(54) PAINT SPRAY SYSTEM AND AIR CONTROL MECHANISM FOR A PAINT SPRAY SYSTEM

(71) Applicant: J. Wagner GmbH, Markdorf (DE)

(72) Inventors: Elmar KRAYER, Langenargen (DE); Thomas JELTSCH, Friedrichshafen (DE); Alfred GÖHRING, Salem (DE); Jens ULBRICH, Friedrichshafen (DE)

(21) Appl. No.: 14/838,829

(22) Filed: Aug. 28, 2015

(30) Foreign Application Priority Data
Sep. 2, 2014 (DE) 10 2014 112 640.8

(51) Int. Cl. B05B 7/24; B05B 7/12

(52) U.S. Cl. CPC B05B 7/2424; B05B 7/12; B05B 7/2418; B05B 7/2478

(57) ABSTRACT

A paint spray system including paint sprayer, a pressurized air generator, a pressurized air duct and an air control mechanism. The paint sprayer has a spray nozzle, the pressurized air generator has a blower, the pressurized air duct connects the blower to the spray nozzle, and the air control mechanism includes a throttle mechanism and is situated in the course of the pressurized air duct. The air control mechanism includes an outlet mechanism, wherein a decreasing of an aperture cross section of the throttle mechanism automatically leads to an increasing of an aperture cross section of the outlet mechanism and vice versa. The aperture cross sections existing in individual settings of the throttle mechanism and the outlet mechanism are attuned to each other such that a dynamic pressure generated at the blower remains constant in the individual aperture settings of the throttle mechanism and the outlet mechanism.

This application claims the benefit under 35 USC §119(a)-(d) of German Application No. 10 2014 112 640.8 filed Sep. 2, 2014, the entirety of which is incorporated herein by reference.

### FIELD OF THE INVENTION

The present invention relates to a paint spray system, especially an HVLP paint spray system, and an air control mechanism for a paint spray system.

### BACKGROUND OF THE INVENTION

A paint spray system is known from DE 20 2006 011 671 U1, which comprises a paint sprayer, a pressurized air generator, a pressurized air duct and an air control mechanism, wherein the paint sprayer has a spray nozzle, wherein the pressurized air generator has a blower, wherein the pressurized air duct connects the blower to the spray nozzle, wherein the air control mechanism comprises a throttle mechanism, and wherein the air control mechanism is situated in the course of the pressurized air duct.

### SUMMARY OF THE INVENTION

The problem which the present invention proposes to solve is the development of a paint spray system and an air control mechanism in which the air flow through the blower or the working point of the blower is held constant despite a change in the volume of an air flow supplied to the nozzle, so that the paint spray system can be designed without costly electric power adjustment, yet still provide an altered air flow to the nozzle.

In the paint spray system of the present invention, the air control mechanism comprises an outlet mechanism, through which pressurized air can flow out into the surroundings, wherein a decreasing of an aperture cross section of the throttle mechanism automatically leads to an increasing of an aperture cross section of the outlet mechanism and wherein an increasing of the aperture cross section of the throttle mechanism automatically leads to a decreasing of the aperture cross section of the outlet mechanism and wherein the aperture cross sections existing in individual settings of the throttle mechanism and the outlet mechanism are attuned to each other such that a dynamic pressure generated at the blower remains constant in the individual aperture settings of the throttle mechanism and the outlet mechanism. This ensures that the blower works under constant conditions and thus optimally, regardless of a volume of air flow supplied to the nozzle, and neither heats up unacceptably as a result of a high dynamic pressure nor delivers a higher volume flow as a result of a low dynamic pressure, which creates a needless amount of moving air in the vicinity of the painting work and increases the electricity consumption. Thus, the crux of the invention is to maintain constant dynamic pressure at the blower by attuning the aperture cross sections of the throttle mechanism and the outlet mechanism in each setting of the throttle mechanism and in each setting of the outlet mechanism.

Furthermore, the air control mechanism comprises coupling means, wherein the coupling means connect the throttle mechanism and the outlet mechanism such that an actuator determining the aperture cross section of the throttle mechanism and an actuator determining the aperture cross section of the outlet mechanism are mechanically or electromechanically or electronically or pneumatically or hydraulically coupled to each other. The coupling means enable both a synchronous adjustment of the throttle mechanism and the outlet mechanism and an arrangement of the throttle mechanism and the outlet mechanism separate from each other, as well as the realization of a translation between the throttle mechanism and the outlet mechanism so that their aperture cross sections, which they make clear in the individual settings, can be predetermined according to the requirements.

Furthermore, when the paint spray system has a multiple-piece design in which the pressurized air generator, the pressurized air duct and the paint sprayer are designed as separate individual components, the throttle mechanism and the outlet mechanism of the air control mechanism are arranged in the pressurized air duct preferably in the immediate vicinity of the pressurized air generator or preferably in the immediate vicinity of the paint sprayer or in the paint sprayer or in the pressurized air generator. An arrangement near the pressurized air generator or in the pressurized air generator brings the advantage that the outlet mechanism is far away from the spray nozzle and air emerging through the outlet mechanism does not affect the spray jet. An arrangement near the paint sprayer or in the paint sprayer brings the advantage that the user can conveniently make an adjustment to the setting.

When the paint spray system has a single piece design in which the pressurized air generator, the pressurized air duct, the paint sprayer and the air control mechanism are designed as a single-piece compact unit, the air control mechanism with its throttle mechanism and its outlet mechanism are arranged in the pressurized air duct or immediately upstream from the spray nozzle or immediately downstream from the blower. Once again, this brings the advantages indicated in the previous paragraph.

It is also provided that the air control mechanism is outfitted with activating means, wherein a changing of the aperture cross section of the pressurized air duct and a changing of the aperture cross section of the outlet mechanism is done by the activating means, wherein the activating means in particular is adjustable continuously or in steps and in particular in a locking or nonlocking manner and/or wherein an adjusting of the activating means changes the aperture cross sections in a linear manner or changes the aperture cross sections in a nonlinear manner and/or wherein the activating means are configured as the housing of a muffler and/or as part of the air guidance mechanism and especially as a guide vane or air scoop. In this way, the desired adjustment of the pressurized air for the spray nozzle can be done with one hand on the activating means, without having to interrupt the spraying or painting process for this or without having to set down the paint sprayer for this.

Furthermore, the directional control valve comprises a guide element and a bearing element, wherein the guide element is configured in particular as a linear slider or rotary slider and is moved with the activating element and wherein the bearing element is arranged in the pressurized air duct in the pressurized air flow direction upstream from the guide element. This enables a mechanically simple construction, which additionally offers the advantage that the guide element is pressed by the pressurized air against the bearing element, thereby accomplishing a sealing between these two structural parts.

It is also provided that the outlet mechanism is outfitted with a muffler, wherein the muffler comprises in particular an open-pore foam body through which pressurized air emerging from an outlet opening of the outlet mechanism is taken, and/or the outlet mechanism is outfitted with an air guidance mechanism which is placed after an outlet opening of the outlet mechanism, wherein the air guidance mechanism deflects outgoing pressurized air at an angle of at least 90° from a spraying direction of the paint sprayer. In this way, one can both avoid unwanted noise production and also prevent an unwanted influencing of the spray jet by the pressurized air emerging from the outlet duct.

It is also provided that the paint spray system is outfitted with a paint tank, whose paint is delivered with pressurized air, which branches off from the pressurized air duct, wherein the pressurized air for the operation of the paint tank is diverted from the pressurized air duct looking in the direction of flow from a first supply connection, arranged upstream from the air control mechanism, or from a second supply connection, arranged downstream from the air control mechanism, or from both supply connections. In this way, once the volume of pressurized air taken to the spray mechanism has been adjusted, such that the volume flow taken to the spray mechanism is reduced, it is possible to supply the paint tank with higher or lower pressure as necessary.

Furthermore, it is provided that the paint tank is connected to the two supply connections across a switching valve via two supply lines, wherein depending on a switch setting of the switching valve pressurized air is fed to the paint tank from only one of the two supply connections or pressurized air is supplied to the paint tank from both supply connections. Thereby, one can easily realize a supply of pressurized air to the paint tank which can be adapted to three pressure levels.

Finally, the invention provides for the configuration of an air control mechanism as a retrofitted part, wherein the air control mechanism comprises a throttle mechanism and an outlet mechanism, wherein a decreasing of an aperture cross section of the throttle mechanism automatically leads to an increasing of an aperture cross section of the outlet mechanism and wherein an increasing of an aperture cross section of the throttle mechanism automatically leads to a decreasing of the aperture cross section of the outlet mechanism, and wherein the aperture cross sections existing in individual settings of the throttle mechanism and the outlet mechanism are attuned to each other such that, when the air control mechanism is installed between the blower and the spray nozzle, a dynamic pressure generated at the blower remains constant in the individual settings. With such a retrofitted part or such an adapter, an existing paint spray system can be easily retrofitted so that the volume of pressurized air supplied to its spray nozzle can be changed without increasing the dynamic pressure at the pressurized air generator or without changing its intended operating point.

In the sense of the invention, by a paint spray system is meant both paint spray systems which comprise a paint spray gun and paint spray systems which comprise a paint spray lance. Furthermore, both variants include either an integrated pressurized air generator or a pressurized air generator which is connected across a pressurized air hose.

In the sense of the invention, a blower of a pressurized air generator is designed in particular as a radial blower. A radial blower here is a blower which takes in air parallel or axially to an axis of rotation of a fanwheel and blows it out by rotation of the fanwheel deflected through 90° and radially to its axis of rotation.

In the sense of the invention, by constant dynamic pressure is meant a dynamic pressure at the blower in particular, which deviates at most 10% upward or at most 20% downward during adjustments to the air control mechanism, but preferably at most by only 5% upward or at most only 10% downward from a nominal pressure.

In the air control mechanism of the invention, in the direction of flow from the blower to the gun, the outlet mechanism for delivering pressurized air to the surroundings is arranged upstream from the throttle mechanism, i.e. before the throttle mechanism, or at least at the position of the throttle mechanism which is placed in the flow duct to the spray nozzle.

### BRIEF DESCRIPTION OF THE DRAWINGS

FIG. 1 is a schematic representation of a paint spray system according to the invention;

FIG. 2 is a first variant embodiment of an air control mechanism of the paint spray system shown in FIG. 1 in exploded view;

FIG. 3 is a perspective representation of a rotary insert belonging to the air control mechanism shown in FIG. 2;

FIG. 4 is the air control mechanism shown in FIGS. 2 and 3 in fully installed condition in a perspective representation;

FIG. 5 is the air control mechanism shown in FIGS. 2 and 3 in fully installed condition in top view, the throttle mechanism being set to minimum flow rate;

FIG. 6 is a sectional view through the representation of FIG. 5, corresponding to sectioning line V-V;

FIG. 7 is a sectional view through the representation of FIG. 6, corresponding to sectioning line VI-VI;

FIG. 8 is a representation of FIG. 6 looking in direction VIII;

FIG. 9 is a perspective view of the sectional representation shown in FIG. 6;

FIG. 10 is the air control mechanism shown in FIGS. 2 and 3 in fully installed condition in top view, the throttle mechanism being set to minimum flow rate;

FIG. 11 is a sectional view through the representation of FIG. 10, corresponding to sectioning line XI-XI;

FIG. 12 is a sectional view through the representation of FIG. 11, corresponding to sectioning line XII-XII;

FIG. 13 is a representation of FIG. 10 looking in direction VIII;

FIG. 14 is a perspective view of the sectional representation shown in FIG. 11;

FIG. 15 is a second variant embodiment of an air control mechanism of the paint spray system shown in FIG. 1 in sectional side view;

FIG. 16 is a third variant embodiment of an air control mechanism of the paint spray system shown in FIG. 1 in sectional side view;

FIG. 17 is a fourth variant embodiment of an air control mechanism of the paint spray system shown in FIG. 1 in sectional side view;

FIG. 18 is a fifth variant embodiment of an air control mechanism of the paint spray system shown in FIG. 1 in sectional side view;

FIG. 19 is a schematic representation of a second paint spray system which is designed as a single-piece paint spray system and

FIG. 20 is a schematic representation of a sixth air control mechanism.

### DETAILED DESCRIPTION OF THE INVENTION

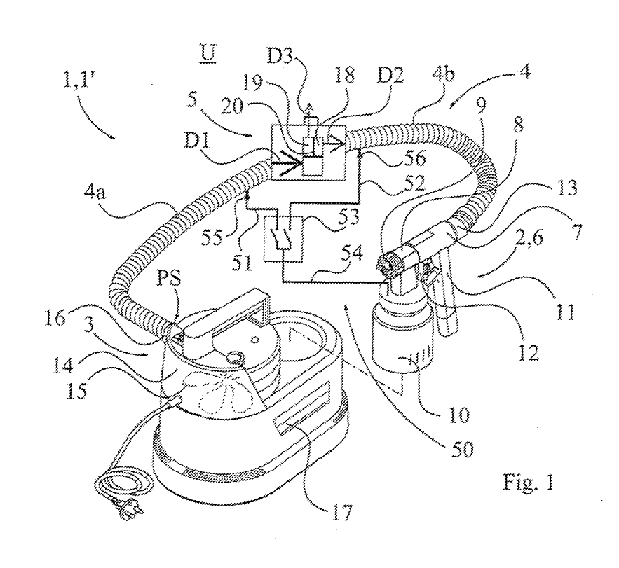

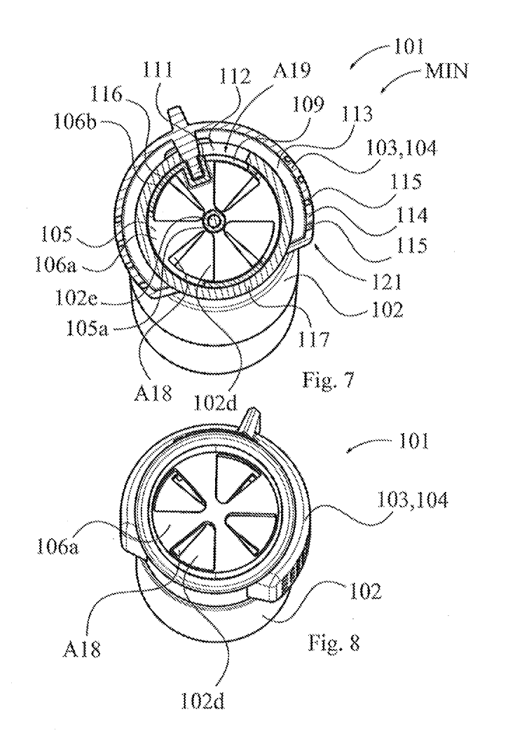

FIG. 1 shows schematically a paint spray system 1 according to the invention. The paint spray system 1 is designed as a High-Volume-Low-Pressure paint spray system 1′ or HVLP paint spray system. The paint spray system 1 comprises a paint sprayer 2, a pressurized air generator 3, a pressurized air duct 4 and an air control mechanism 5. The paint sprayer 2 is designed as a spray gun 6 and comprises a housing 7, a front end 8 with a spray nozzle 9, a paint tank 10, a handle 11 with a trigger 12 and a connection 13 for the pressurized air duct 4. The pressurized air generator 3 comprises a housing 14, an electric blower 15, a connection 16 for the pressurized air duct 4 and an air inlet 17 for taking in ambient air. The pressurized air duct 4 connects the blower 15 to the spray nozzle 9 across the connections 16 and 13. The air control mechanism 5 shown schematically in FIG. 1 in turn comprises a throttle mechanism 18 and an outlet mechanism 19 and is arranged in the pressurized air duct 4. The air control mechanism 5 is supplied with pressurized air D1 at the blower side from the blower 15 across a first segment 4a of the pressurized air duct 4. The pressurized air D1 in the air control mechanism 5 at the blower side is either conducted further into a second segment 4b of the pressurized air duct 4 to the spray nozzle 9 with the outlet mechanism 19 closed and the throttle mechanism 18 fully open, or the pressurized air D1 at the blower side is further conducted, as shown symbolically by arrows in FIG. 1, as a first portion of pressurized air D2 at the spray side with the throttle mechanism 18 partly closed to the spray nozzle 9 and blown out to the surroundings U as a second portion with outlet mechanism 19 partly open as exhaust air D3. In this case, an aperture cross section A18 (see FIG. 7) of the throttle mechanism 18 and an aperture cross section A19 (see FIG. 7) of the outlet mechanism 19 in each position of the adjustment dictated by the throttle mechanism 18 and in each position dictated by the outlet mechanism 19 are attuned to each other by experiments or calculations so that a dynamic pressure PS prevailing at the blower 15, e.g. at the connection 16, remains constant regardless of any setting dictated by the throttle mechanism 18 for the outlet mechanism 19 or by the outlet mechanism 19 for the throttle mechanism 18. The air control mechanism 5 also comprises coupling means 20. The coupling means 20 connect the throttle mechanism 18 and the outlet mechanism 19 such that an actuator determining the aperture cross section A18 of the throttle mechanism 18 and an actuator determining the aperture cross section A19 of the outlet mechanism 19 are mechanically connected to each other.

According to variant embodiments not shown, an electromechanical or an electronic coupling of the actuators of the throttle mechanism and the outlet mechanism is also provided. An electromechanical coupling comprises a driving means, especially an electric motor, and a force transmittal means powered by the driving means, especially a toothed rack or a belt, wherein the force transmittal means acts on the two actuators and moves them. An electronic coupling comprises two driving means, especially two electric motors or two electromagnets, electronics, and a manually operated controller, wherein the electronics actuate the driving means depending on a selected setting or adjustment of the controller, which is configured in particular as a slide control or rotary controller or by two keys, while each driving means is connected to one actuator and the driving means bring the actuators into positions dictated by the electronics.

FIG. 1 shows the paint spray system 1 in a multiple-piece design, in which the pressurized air generator 3, the pressurized air duct 4 and the paint sprayer 6 are designed as separate individual components for transport, cleaning or storage purposes. The air control mechanism 5 with its throttle mechanism 18 and its outlet mechanism 19 are arranged here in the pressurized air duct 4. This ensures that exhaust air D3 blown out from the outlet mechanism 19 into the surroundings U does not have any disturbing influence on the spraying work.

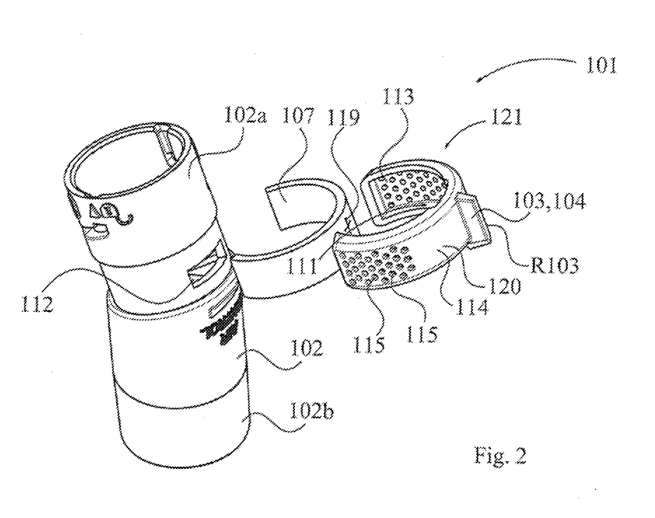

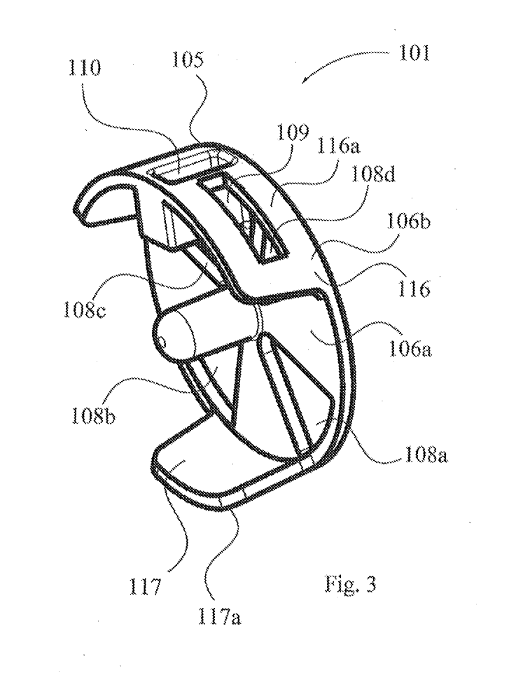

FIGS. 2 and 3 show a first variant embodiment of the air control mechanism of the paint spray system shown in FIG. 1 in exploded view. The air control mechanism 101 shown as individual parts in FIGS. 2 and 3 is configured as an adapter, which can be installed in the pressurized air duct 4 (see FIG. 1). The air control mechanism 101 comprises an adapter pipe 102, an activating means 104 designed as a clasp 103, a rotary insert 105, which is formed by a first actuator 106a and a second actuator 106b (see FIG. 3), and a muffler 107. The adapter pipe 102 comprises a first connection 102a for attaching the first segment 4a of the pressurized air duct 4 and a second connection 102b for attaching the second segment 4b of the pressurized air duct 4 (see FIGS. 1 and 2).

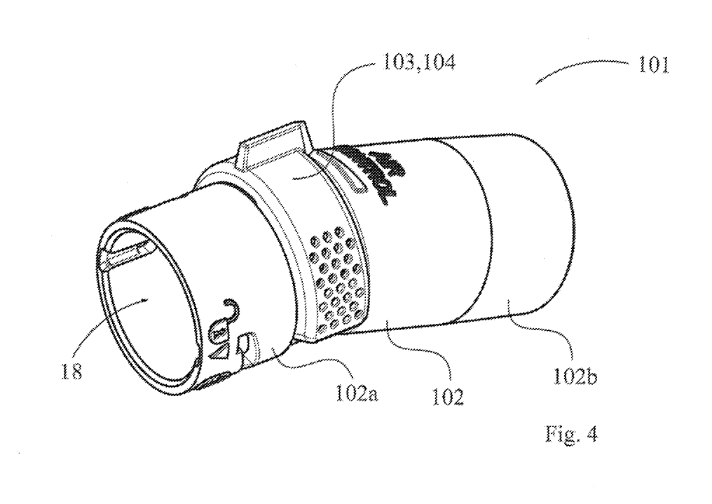

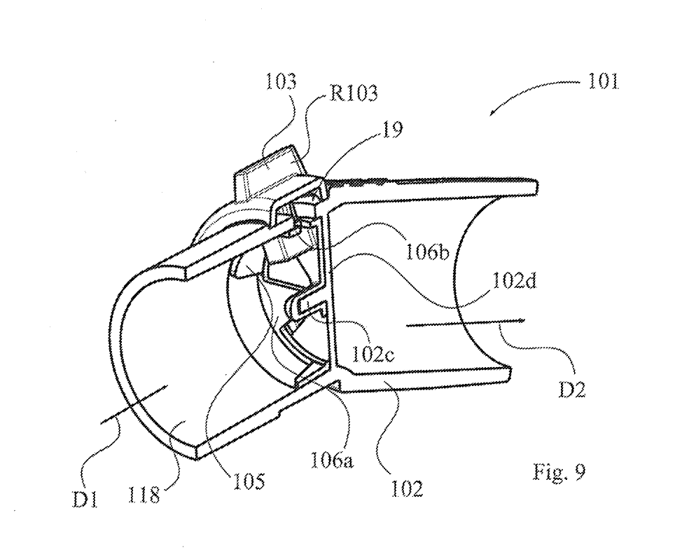

FIGS. 4 to 9 show different views of the air control mechanism 101, wherein the air control mechanism 101 is in an assembled condition here and stands in a position in which its throttle mechanism 18 is set for a minimum flow rate.

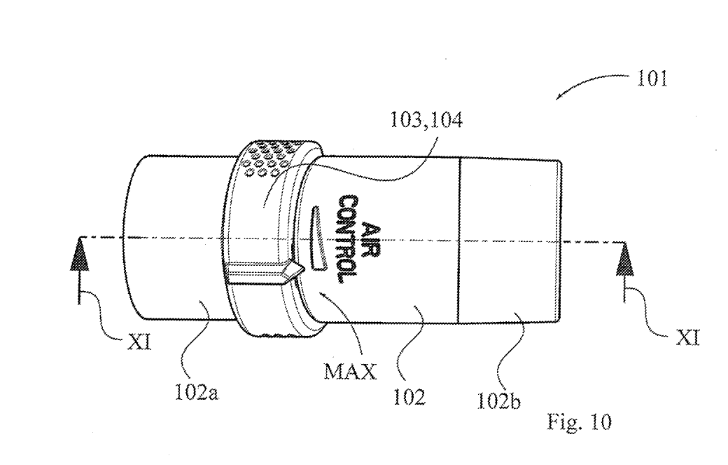

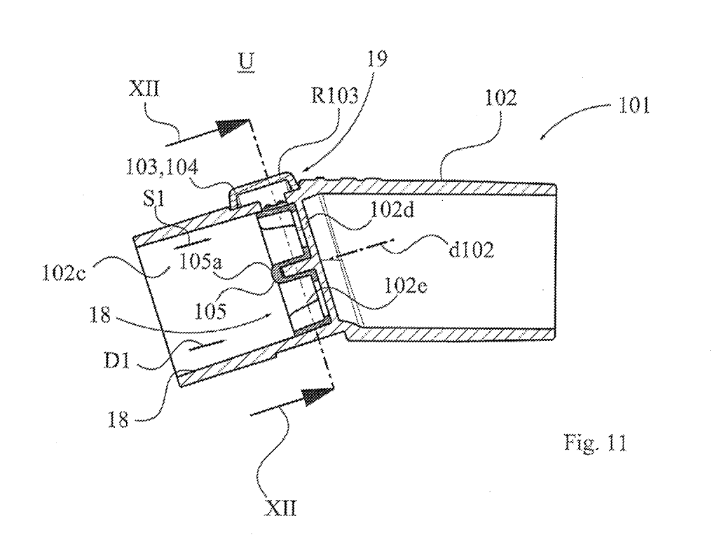

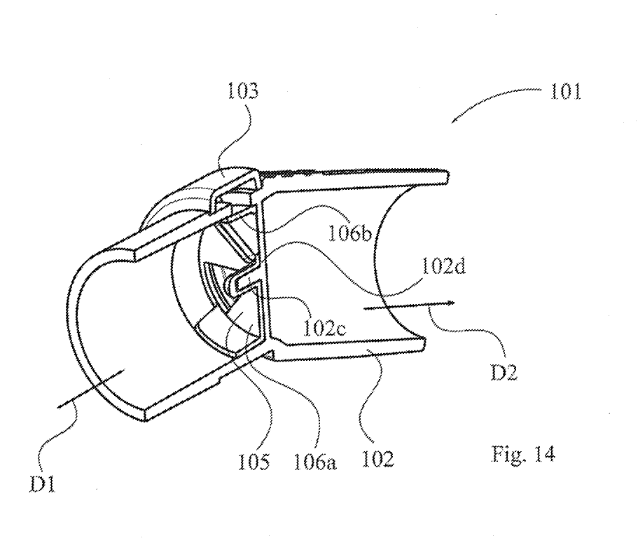

FIGS. 10 to 14 show different views of the air control mechanism 101, wherein the air control mechanism 101 is likewise in an assembled condition here, but stands in a position in which its throttle mechanism 18 is set for a maximum flow rate.

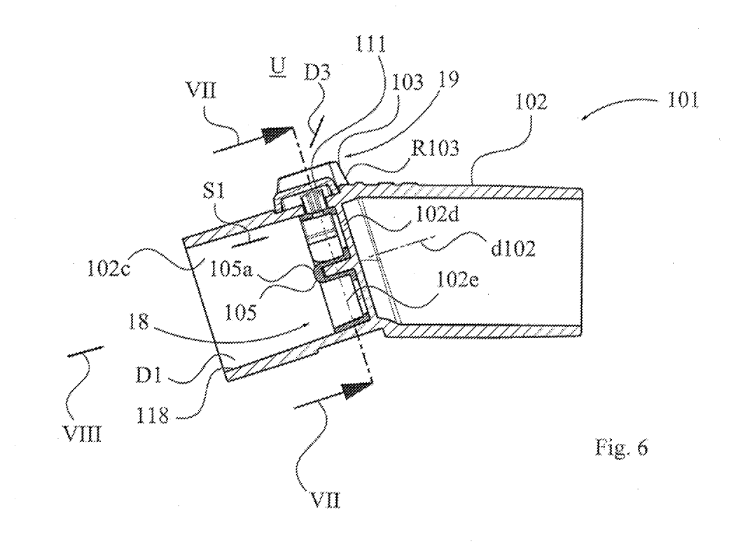

As is evident for example from FIGS. 6 to 9, the rotary insert 105, which together with a perforated wall 102d formed in a channel 102c of the adapter pipe 102 forms the throttle mechanism 18 (see FIG. 6), can turn about an axis of rotation d102 in the assembled state of the air control mechanism 101 in the adapter pipe 102. The rotary insert 105 is supported by a journal 102e formed on the wall 102d. The journal 102e projects into a seat 105a of the rotary insert 105. In order to ensure a reliable bearing of the rotary insert 105 against the wall 102d in operation, the journal 102e is directed from the wall 102d against a direction of flow S1 of the pressurized air D1, so that the rotary insert 105 in operation is pressed by the pressurized air D1 flowing through the adapter pipe 102 against the wall 102d.

It is evident from FIG. 3 that the rotary insert 105 has four axially oriented triangular openings 108a to 108d in its first guide element 106a and an axially oriented slotlike opening 109 in its second guide element 106b. Furthermore, a pocket 110 is formed beside the slotlike opening 109. This pocket 110 is matched up with a lug 111, which is formed on the clasp 103 beneath a handle grip R103. In the assembled condition of the air control mechanism 101, the clasp 103 reaches by its lug 111 through a window 112 formed in the adapter pipe 102 (see FIGS. 2, 3 and 6) into the pocket 110 of the rotary insert 105, so that the clasp 103 and the rotary insert 105 are coupled together and the rotary insert 105 can turn about the axis 102e on the outside by means of the clasp 103. The turning ability here is limited to an angle of rotation allowed by the window 112 for the lug 111. The window 112 formed in the adapter pipe 102 has a dual function and not only forms a passageway for the lug 111 of the clasp 103, but also forms an outlet opening 112a for pressurized air D3 of the outlet mechanism 19, which is formed by the actuator 106b configured on the rotary insert 105 and the adapter pipe 102 with the window 112. In this way, it is possible for the pressurized air D1 to flow out into the surroundings U as pressurized air D3, in which the rotary insert 105 is oriented by its slotlike opening 109 toward the window 112 in the adapter pipe 102. Inasmuch as the opening 109 and the window 112 are oriented toward each other (see, for example, FIG. 7), a portion of the pressurized air D1 emerges as pressurized air D3 through the opening 109 and the window 112 into a space 113 situated between the clasp 103 and the adapter pipe 102. Thus, the opening 109 forms an outlet opening 109a of the outlet mechanism 19. The space 113 is filled by the muffler 107, which is configured as foam plastic. Accordingly, noise produced by the escaping pressurized air D3 is dampened and the emerging pressurized air D3 leaves the space 113 through outlet boreholes 115 fashioned in a wall 114 of the clasp 103. The opening 109 and the pocket 110 are formed in a first wing 116 of the rotary insert 105. The rotary insert 105 comprises a second wing 117, which lies opposite the first wing 116, so that the rotary insert 105 is braced by the outer surfaces 116a and 117a of its opposite wings 116, 117 against an inner wall 118 of the adapter pipe 102 and a skewing of the rotary insert 105 due to an activation by the clasp 103 is prevented. In FIG. 2, an opening 119 is indicated at the muffler 107, through which the clasp 103 enters by its lug 111 when it is coupled with the rotary insert 105.

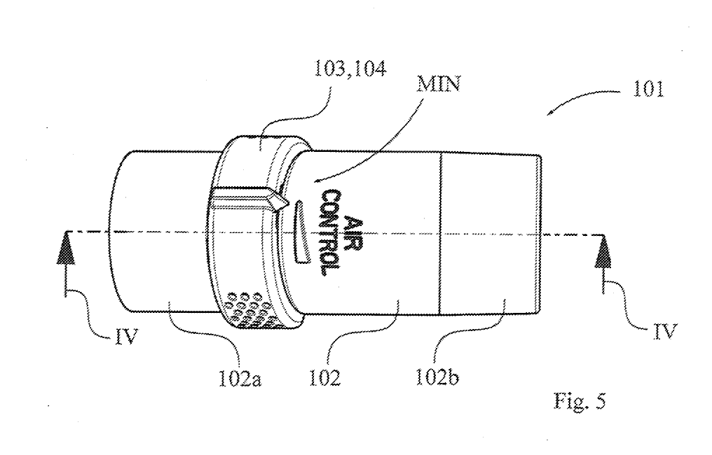

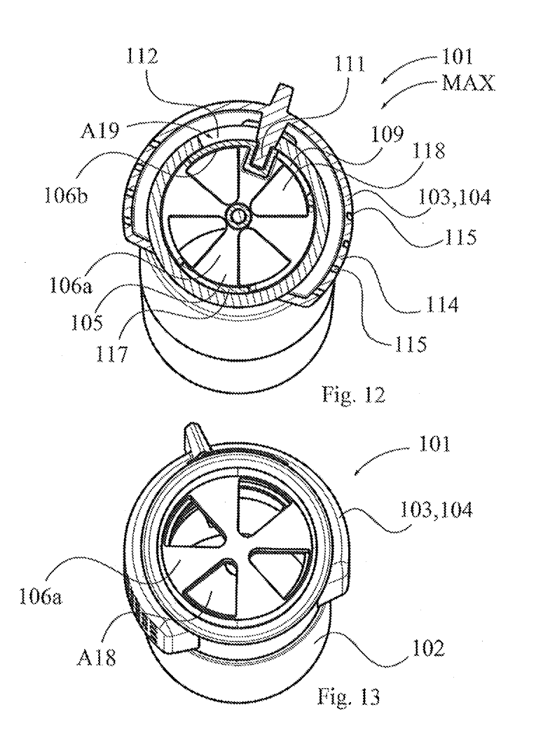

Thanks to the activating means 104 of the air control mechanism 101 fashioned as a clasp 103, when the activating means 104 is turned about the axis of rotation d102 there occurs a changing of the aperture cross section A18 of the throttle mechanism 18 and at the same time a changing of the aperture cross section A19 of the outlet mechanism 19. The activating means 104 can move continuously and without locking between a minimum setting MIN indicated in FIGS. 5 to 9 and a maximum setting MAX indicated in FIGS. 10 to 14. In the minimum setting MIN (see especially FIG. 7) the aperture cross section A18 of the throttle mechanism is reduced to a minimum and the aperture cross section A19 of the outlet mechanism 19 is opened to a maximum. In the maximum setting MAX (see especially FIG. 12) the aperture cross section A18 of the throttle mechanism is opened to a maximum and the aperture cross section A19 of the outlet mechanism 19 is totally closed. By adjusting the activating means 104, the aperture cross section A18 of the throttle mechanism 18 is changed by a first function depending on the angle of rotation and the aperture cross section A19 of the outlet mechanism 19 is changed by a second function depending on the angle of rotation. The activating means 104 is designed not only as a housing of the muffler 107, but also as part of the air guide mechanism 101 it forms an air scoop 120, which deflects the pressurized air D3 to opposite sides. Coupling means 121 of the air guide mechanism 101 are formed in the present design by the clasp 103 and the activating means 104, since the clasp 103 is used to activate both the first actuator 106a and the throttle mechanism 18 comprising the wall 102d and also the second actuator 106b and the outlet mechanism 19 comprising the adapter pipe 102 with the window 112. In this case, the two actuators 106a and 106b form a single-piece guide element 122 for the pressurized air and the wall 102d and the inner wall 118 of the adapter pipe 102 form a bearing element 123 for the guide element 122. The guide element 122 in the form of the rotary insert 105 is fashioned as a rotary slider 124.

FIG. 1 furthermore shows schematically a pressurized air supply 50 for the paint tank 10, by which paint is delivered from the paint tank 10 to the spray nozzle 9. The pressurized air supply 50 comprises two feed lines 51, 52, a switch valve 53 and a supply line 54. Through the feed lines 51, 52 the switch valve 53 is connected to a supply connection 55 arranged at the pressurized air duct 4 upstream from the air control mechanism 5 in the flow direction of pressurized air and to a supply connection 56 arranged downstream from the air control mechanism 5 at the pressurized air duct 4, so that pressurized air flows via both feed lines 51, 52 to the switch valve 53. The switch valve 53 depending on its switch setting conveys pressurized air via the supply line 54 to the paint tank 10. The paint tank 10 is either supplied exclusively with pressurized air from the first supply connection 55 in a first switch setting of the switch valve or exclusively with pressurized air from the second supply connection 56 in a second switch setting of the switch valve or in a third switch setting it is supplied with pressurized air from both supply connections 55, 56 or in a fourth switch setting it is blocked off from pressurized air supply. Once the throttle mechanism 18 is not in a maximum setting and the pressurized air can flow unhindered through the air control mechanism 5, the pressurized air will be present at the two supply connections 55, 56 with different pressure, so that the more suitable pressure for the delivery of the paint can be chosen. Thanks to the third switch setting of the switch valve a further pressure potential is available lying between the first and the second pressure potential.

According to another variant embodiment it is also provided that the pressurized air supply comprises only one supply line, by which the paint tank is manually connected optionally to the first or the second supply connection, while the supply connection to which the supply line is not connected is naturally closed, for which it is designed in particular as a self-closing valve.

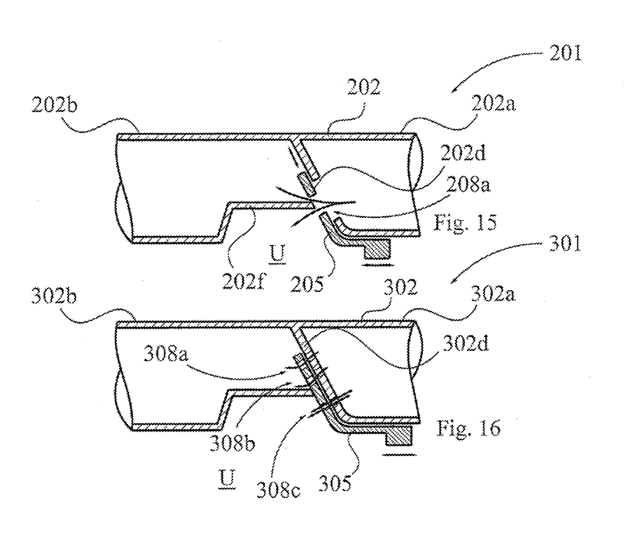

FIG. 15 shows a second variant embodiment of an air control mechanism 201 of the paint spray system of FIG. 1 in sectional side view. The air control mechanism 201 comprises an adapter pipe 202 with a first and a second connection 202a, 202b for the pressurized air duct 4 shown in FIG. 1. Moreover, the air control mechanism 201 comprises a slide insert 205 with an opening 208a, which can be shifted in linear manner in front of a perforated wall 202d of the adapter pipe 202 and routes the pressurized air depending on its position with respect to a recess 202f of the adapter pipe 202 to different parts in the adapter pipe 202 and out from the adapter pipe 202 into the surroundings U. The slide insert 205 forms a linear slide 225.

In FIG. 16 is shown a third variant embodiment of an air control mechanism 301 of the paint spray system of FIG. 1 in sectional side view. The air control mechanism 301 comprises an adapter pipe 302 with a first and a second connection 302a, 302b for the pressurized air duct 4 shown in FIG. 1. Moreover, the air control mechanism 301 comprises a slide insert 305 with three openings 308a, 308b and 308c, which can be moved in a linear manner and lies behind a triple-perforated wall 302d of the adapter pipe 302 and routes the pressurized air depending on its position to different parts in the adapter pipe 302 and out from the adapter pipe 302 into the surroundings U, where the openings 308a and 308b emerge into the adapter pipe 302 and the opening 308c emerges into the surroundings U. The slide insert 305 forms a linear slide 325.

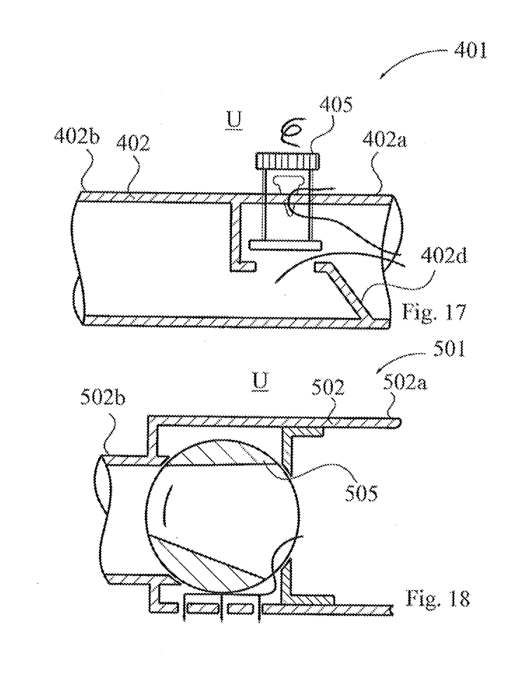

FIG. 17 shows a fourth variant embodiment of an air control mechanism 401 of the paint spray systems of FIG. 1 in sectional side view. The air control mechanism 401 comprises an adapter pipe 402 with a first and a second connection 402a, 402b for the pressurized air duct 4 shown in FIG. 1. Furthermore, the air control mechanism 401 comprises a screw insert 405, by which a single perforated wall 402d of the adapter pipe 402 can be closed, wherein the pressurized air under increasing closure of the wall 402d can flow out into the surroundings U through an increasing opening of the screw insert.

FIG. 18 shows schematically a fifth variant embodiment of an air control mechanism 501 of the paint spray systems of FIG. 1 in sectional side view. The air control mechanism 501 comprises an adapter pipe 502 with a first and a second connection 502a, 502b for the pressurized air duct 4 shown in FIG. 1. Furthermore, the air control mechanism 501 comprises a rotary insert 505, which is fashioned as a rotary plug and admits an increasing outflow of pressurized air into the surroundings U when turned from a middle position.

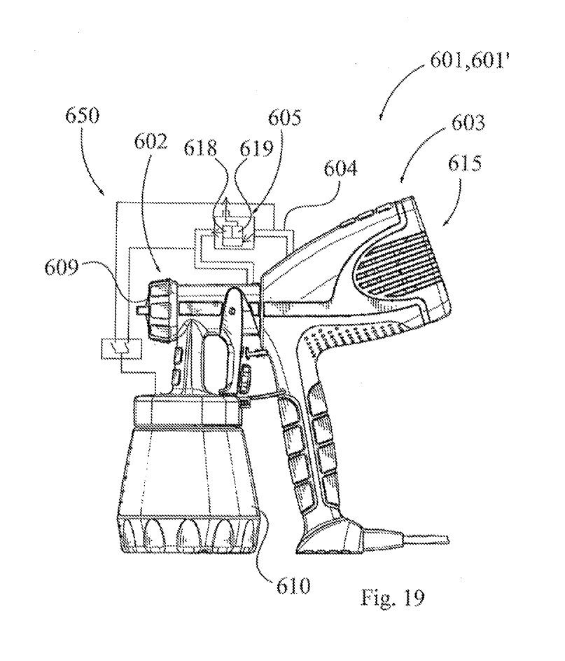

FIG. 19 shows schematically a second paint spray system 601. This is designed as a single-piece paint spray system 601. In the single-piece paint spray system 601 a pressurized air generator 603, a pressurized air duct 604, a paint sprayer 602 and an air control mechanism 605 form a single-piece compact appliance. The pressurized air generator 603 comprises an electric blower 615 and the paint sprayer 602 comprises a spray nozzle 609. The air control mechanism 605 here with a throttle mechanism 618 and an outlet mechanism 619 is arranged in the pressurized air duct 604. In regard to the function of the air control mechanism 605, refer to the description of the air control mechanism shown in FIG. 1. Optionally, the second paint spray system 601, which is designed as an HVLP paint spray system 601′, also comprises a pressurized air supply 650 for a paint tank 610 of the paint sprayer 602. Regarding the function of the pressurized air supply 650, refer to the description of the pressurized air supply shown in FIG. 1.

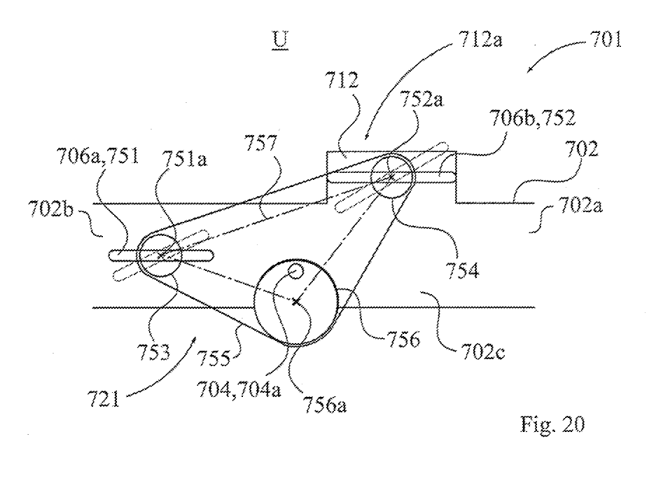

FIG. 20 shows schematically a sixth variant embodiment of an air control mechanism 701. The air control mechanism 701 comprises an adapter pipe 702 with a first and a second connection 702a, 702b. In a channel 702c there is fashioned a window 712, which forms an outlet opening 712a. In the channel 702c is arranged a first actuator 706a in the form of a first pivoting flap 751. In the outlet opening 712a is arranged a second actuator 706b in the form of a second pivoting flap 752. Both flaps 751, 752 are each connected to a gear 753, 754, so that a rotation of the gears about axes of rotation 751a, 752a of the flaps 751, 752 also produces a rotation of the flap 751, 752. As coupling means 721, the air control mechanism 701 comprises a toothed belt 755 and another gear 756 with axis of rotation 756a. The three gears 753, 754 and 756 are arranged at corner points of an imaginary triangle 757 and the toothed belt 755 is passed around them such that a rotation of the third gear 756 is transmitted via the toothed belt 755 to the gears 753 and 754 and thus brings about a turning of the flaps 751, 752. The flap 751 here is shown by solid lines in a position in which the channel 702c is fully open and the flap 752 here is shown by solid lines in a position in which the outlet opening 712a is fully closed. In this position, a full volume flow will be taken to a spray nozzle, not shown. By broken lines is shown an intermediate position of the air control mechanism 701, in which the channel 702c is slightly closed and the outlet opening 712a is slightly opened. In this position, a reduced volume flow is taken to the spray nozzle, not shown, and a lesser volume flow, corresponding to a difference between the full volume flow and the reduced volume flow, is taken via the outlet opening 712a into the surroundings U. Thanks to a use of gears 753, 754 with different diameters, the mechanical coupling of the actuators 706a, 706b can be adapted, so that the air control mechanism 701 can also be operated with greatly different diameters of the flaps, so that a dynamic pressure on a blower is maintained constant at all adjustments of the air control mechanism. As activating means 704 a pin 704a is used, which is connected eccentrically to the third gear 756, so that the gear 756 can be turned by hand through any given angle.

### LIST OF REFERENCE NUMBERS

1 paint spray system
1′ HVLP paint spray system
2 paint sprayer
3 pressurized air generator
4 pressurized air duct
4a, 4b first, second segment of 4
5 air control mechanism
6 spray gun
7 housing of 7
8 front end of 7
9 spray nozzle of 7
10 paint tank of 7
11 handle of 7
12 trigger of 7
13 connection of 7
14 housing of 3
15 blower of 3
16 connection of 3
17 air inlet of 3
18 throttle mechanism of 5
19 outlet mechanism of 5
20 coupling means of 5
50 pressurized air supply
51, 52 supply lines to 53
53 switching valve to 53
54 supply line between 53 and 10
55, 56 supply connections at 4
101 air control mechanism (first variant)
102 adapter pipe
102a first connection at 102
102b second connection at 102
102c channel of 102
102d perforated wall in 102
102e journal on 102d
103 clasp
104 activating means
105 rotary insert
106a first actuator
106b second actuator
107 muffler
108a-108d opening at 105 and 106a
109 opening at 105 and 106b
110 pocket at 105
111 lug at 103
112 window in 102
112a outlet opening formed by 112
113 space between 102 and 103
114 wall of 103
115 outlet borehole in 114
116 first wing of 105
116a outer surfaces of 116
117 second wing of 105
117a outer surfaces of 117
118 inner wall of 102
119 opening on 107
120 air scoop at 103
121 coupling means
122 guide element
123 bearing element for 122
201 air control mechanism
202 adapter pipe
202a, 202b connection at 202
202d perforated wall of 202
202f recess of 202
205 slide insert
208a opening in 205
225 linear slider
301 air control mechanism
302 adapter pipe
302a, 302b connection of 302
302d perforated wall of 302
305 slide insert
308a-308c openings in 305
325 linear slider
401 air control mechanism
402 adapter pipe
402a, 402b connection of 402
402d perforated wall of 402
405 screw insert
501 air control mechanism
502 adapter pipe
502a, 502b connection of 502
505 rotary insert
601 single-piece paint spray system
601′ HVLP paint spray system
602 paint sprayer
603 pressurized air generator
604 pressurized air duct
605 air control mechanism
609 spray nozzle
610 paint tank
615 blower
618 throttle mechanism
619 outlet mechanism
650 pressurized air supply
701 air control mechanism
702 adapter pipe
702a, 702b first, second connection of 702
702c channel
704 activating means
704a pin
706a first actuator
706b second actuator
712 window in 702
712a outlet opening in 702
721 coupling means
751 first pivoting flap
751a pivot axis of 751
752 first pivoting flap
752a pivot axis of 752
753, 754 gear
755 toothed belt
756 third gear
756a pivot axis of 756
757 imaginary triangle
A18 aperture cross section of 18
A19 aperture cross section of 19
D1 pressurized air at blower side
D2 pressurized air at sprayer side
D3 exhaust air
d102 pivot axis of 105
MIN minimum setting of 101
MAX maximum setting of 101
PS dynamic pressure at 3
R103 grasping rib on 103
S1 flow direction
U surroundings

1. A paint spray system, especially an HVLP paint spray system, comprising:
a paint sprayer, a pressurized air generator, a pressurized air duct and an air control mechanism,
wherein the paint sprayer has a spray nozzle,
wherein the pressurized air generator has a blower,
wherein the pressurized air duct connects the blower to the spray nozzle,
wherein the air control mechanism comprises a throttle mechanism, and
wherein the air control mechanism is situated in the course of the pressurized air duct,
wherein the air control mechanism comprises an outlet mechanism,
wherein a decreasing of an aperture cross section of the throttle mechanism automatically leads to an increasing of an aperture cross section of the outlet mechanism and wherein an increasing of the aperture cross section of the throttle mechanism automatically leads to a decreasing of the aperture cross section of the outlet mechanism,
wherein the aperture cross sections existing in individual settings of the throttle mechanism and the outlet mechanism are attuned to each other such that a dynamic pressure generated at the blower remains constant in the individual aperture settings of the throttle mechanism and the outlet mechanism.

2. The paint spray system according to claim 1, wherein the air control mechanism comprises coupling means,
wherein the coupling means connect the throttle mechanism and the outlet mechanism such that an actuator determining the aperture cross section of the throttle mechanism and an actuator determining the aperture cross section of the outlet mechanism are mechanically or electromechanically or electronically or pneumatically or hydraulically coupled to each other.

3. The paint spray system according to claim 1, wherein the paint spray system has a multiple-piece design in which the pressurized air generator, the pressurized air duct and the paint sprayer are designed as separate individual components, the throttle mechanism and the outlet mechanism of the air control mechanism are arranged
in the pressurized air duct preferably in the immediate vicinity of the pressurized air generator or preferably in the immediate vicinity of the paint sprayer or
in the paint sprayer or
in the pressurized air generator.

4. The paint spray system according to claims 1, wherein the paint spray system has a single-piece design in which the pressurized air generator, the pressurized air duct, the paint sprayer and the air control mechanism are designed as a single-piece compact unit, the air control mechanism with its throttle mechanism and its outlet mechanism is either arranged
in the pressurized air duct or
immediately upstream from the spray nozzle or immediately downstream from the blower.

5. The paint spray system according to claim 1, wherein the air control mechanism comprises activating means, wherein a changing of the aperture cross section of the pressurized air duct and a changing of the aperture cross section of the outlet mechanism is done by the activating means,
wherein the activating means in particular are adjustable continuously or in steps and in particular in a locking or nonlocking manner and/or
wherein an adjusting of the activating means changes the aperture cross sections in a linear manner or changes the aperture cross sections in a nonlinear manner and/or
wherein the activating means are configured as the housing of a muffler and/or as part of the air guidance mechanism and especially as a guide vane or air scoop.

6. The paint spray system according to claim 1, wherein the air control mechanism comprises a guide element and a bearing element, wherein the guide element is configured in particular as a linear slider or rotary slider and is moved with the activating means and wherein the bearing element is arranged in the pressurized air duct in the pressurized air flow direction upstream from the guide element.

7. The paint spray system according to claim 1, wherein
the outlet mechanism is outfitted with a muffler, wherein the muffler comprises in particular an open-pore foam body through which pressurized air emerging from an outlet opening of the outlet mechanism is taken, and/or
the outlet mechanism is outfitted with an air guidance mechanism which is placed after an outlet opening of the outlet mechanism, wherein the air guidance mechanism deflects outgoing pressurized air at an angle of at least 90° from a spraying direction of the paint sprayer.

8. The paint spray system according to claim 1, wherein the paint spray system comprises a paint tank, whose paint is delivered with pressurized air, which branches off from the pressurized air duct, wherein the pressurized air for the operation of the paint tank is diverted from the pressurized air duct looking in the direction of flow from a first supply connection, arranged upstream from the air control mechanism, or from a second supply connection, arranged downstream from the air control mechanism, or from both supply connections.

9. The paint spray system according to claim 8, wherein the paint tank is connected to the two supply connections across a switching valve via two supply lines, wherein depending on a switch setting of the switching valve pressurized air is either fed to the paint tank from only one of the two supply connections or pressurized air is supplied to the paint tank from both supply connections.

10. An air control mechanism, wherein the air control mechanism adapted to be installed in a paint spray system, comprising a paint sprayer, a pressurized air generator and a pressurized air duct, wherein the paint sprayer comprises a spray nozzle and wherein the pressurized air generator comprises a blower, wherein the air control mechanism comprises a throttle mechanism and an outlet mechanism, wherein a decreasing of an aperture cross section of the throttle mechanism automatically leads to an increasing of an aperture cross section of the outlet mechanism and wherein an increasing of an aperture cross section of the throttle mechanism automatically leads to a decreasing of the aperture cross section of the outlet mechanism, and wherein the aperture cross sections existing in individual settings of the throttle mechanism and the outlet mechanism are attuned to each other such that, when the air control mechanism is installed between the blower and the spray nozzle, a dynamic pressure generated at the blower remains constant in the individual settings.
